(19) United States
(12) Patent Application Publication
(10) Pub. No.: US 2017/0138457 A1
(43) Pub. Date: May 18, 2017

(54) GEAR

(71) Applicant: Wittenstein SE, Igersheim (DE)

(72) Inventors: Heiko Schreiber, Gnaschwitz (DE); Michael Schmidt, Reichenberg (DE)

(73) Assignee: Wittenstein SE, Igersheim (DE)

(21) Appl. No.: 15/349,242

(22) Filed: Nov. 11, 2016

(30) Foreign Application Priority Data
Nov. 12, 2015 (DE) 10 2015 119 584.4

(51) Int. Cl. F16H 55/17

(52) U.S. Cl. CPC F16H 55/17

(57) ABSTRACT

Gear mechanism (1), in particular coaxial gear mechanism or linear gear mechanism, having a toothing system (40), a tooth carrier with radially oriented guides, teeth (25, 27) which are received in the guides for engagement with the toothing system, the teeth (25, 27) being mounted in the guides such that they can be displaced radially relative to the tooth carrier in the direction of their longitudinal axis, a cam disk (3) for radially driving the teeth (25, 27), the cam disk having a circumferential profiling, rolling bodies (15, 17) which are arranged on the profiling, and a plurality of pivoting segments (19) for mounting the teeth (25, 27), the pivoting segments being arranged on the rolling bodies (15, 17), the rolling bodies (15, 17) being arranged on the profiling in at least two rolling body rows which are parallel in the circulating direction of the cam disk.

### FIELD OF THE INVENTION

The invention relates to a gear mechanism and to a method for producing a gear mechanism.

### PRIOR ART

Gear mechanisms are known from the prior art which comprise teeth which are mounted radially displaceably in a tooth carrier. In order to drive the teeth, drive elements with a profiling, such as cam disks, are used. The teeth engage into a toothing system, with the result that a relative movement occurs between the tooth carrier with the teeth and the toothing system. Here, the relative movement between the toothing system and the teeth is smaller by at least one order of magnitude than the movement of the drive element with the profiling. In this way, high step-up transmission ratios can be achieved; one example of a gear mechanism of this type is disclosed in DE 10 2007 011 175 A1.

A point which is relevant under some circumstances for the service life of gear mechanisms of this type is the mounting of the so-called pivoting segments on the surface of the cam disk. Previous solutions provide simple anti-friction bearings here, for example with a row of rollers which are arranged between the pivoting segments and the cam disk. Despite the low friction of the anti-friction bearing, fatigue phenomena can occur, however, in this region depending on the loads or age of the gear mechanism.

### DISCLOSURE OF THE INVENTION

It is an object of the invention to specify improved gear mechanisms, in particular those which have improved mounting in comparison with the prior art of the pivoting segments on the cam disk.

The object is achieved by way of a gear mechanism and a method for using a gear mechanism as disclosed herein. Advantageous developments and embodiments result from the subclaims and from this description.

One aspect of the invention relates to a gear mechanism, in particular a coaxial gear mechanism or linear gear mechanism, having a toothing system, a tooth carrier with radially oriented guides, teeth which are received in the guides for engagement with the toothing system, the teeth being mounted in the guides such that they can be displaced radially relative to the tooth carrier in the direction of their longitudinal axis, a cam disk for radially driving the teeth, the cam disk having a circumferential profiling, rolling bodies which are arranged on the profiling, and a plurality of pivoting segments for mounting the teeth, the pivoting segments being arranged on the rolling bodies, the rolling bodies being arranged on the profiling in at least two rolling body rows which are parallel in the circulating direction of the cam disk.

A further aspect of the invention relates to the use of a gear mechanism in one of the typical embodiments which are described herein.

Embodiments of the invention relate, in particular, to coaxial gear mechanisms. Gear mechanisms of the invention usually comprise an inner cam disk as a drive element and an internal gear with an internal toothing system or an outer drive element with an inner profiling and an inner gearwheel or an inner rack which provides the toothing system for the case of the outer drive element. Configurations of embodiments relate to linear gear mechanisms for converting a rotation into a linear movement. The expression “cam disk” is typically generally to be understood in such a way that the corresponding component does not necessarily have to be similar to a disk. Rather, the cam disk can also be part of a drive shaft or can have an elongate extent, in particular with a plurality of sections. One or more sections of this type can have a changing radius, with the result that the function of a cam disk is met. Further sections can have other functions and can be, for example, cylindrical or else can be provided with edges, for example for the transmission of torque. Typically, the expression cam disk relates primarily to the function of the said component, namely to provide a circumferential profiling, in order, for example, according to the angular position of the drive shaft and therefore of the cam disk, to drive the teeth in the radial direction or to permit sliding back of the teeth in the guides.

The toothing system is typically a circumferential toothing system. The teeth or the tooth tips of the teeth engage into the toothing system, the teeth typically being mounted such that they can be displaced in a linearly radial manner relative to the tooth carrier. Here, “in a linearly radial manner” usually means that there is a guide in the radial direction which permits merely a movement of the tooth in the radial direction. A tooth can typically be displaced linearly in precisely one direction as a result of the guide; this can be achieved, for example, by virtue of the fact that the tooth has a constant cross section in the displacement direction over a defined section length, the tooth carrier likewise having an opening for the tooth with a constant cross section. The teeth are usually mounted in the tooth carrier such that they can be displaced in each case in precisely one direction, typically in the direction of the longitudinal axis of the tooth. Furthermore, in the case of typical embodiments, the degree of rotational freedom of the teeth relative to the tooth carrier is blocked about the longitudinal axis of the gear mechanism. This can be achieved, for example, by way of a linear guide of the teeth in the radial direction in the tooth carrier. In this way, the teeth rotate with the tooth carrier about the longitudinal axis of the gear mechanism, but not relative to the tooth carrier.

In typical embodiments of the gear mechanisms according to the invention, at least part of the teeth are of flexurally stiff configuration. Here, the expression “flexurally stiff” is typically to be understood in a technical manner, that is to say bending of the teeth on account of the stiffness of the material of the teeth is so small that it is at least substantially insignificant for the kinematics of the gear mechanism.

Flexurally stiff teeth comprise, in particular, teeth which are produced from a metal alloy, in particular steel or a titanium alloy, a nickel alloy or other alloys. Furthermore, flexurally stiff teeth can also be provided from plastic, in particular in gear mechanisms, in which at least one of the following parts is also likewise produced from plastic: toothing system on an internal gear or a gearwheel, tooth carrier and drive element. In typical embodiments of the invention, the tooth carrier and the teeth are produced from a metal alloy or, in addition, the toothing system or, furthermore in addition, the drive element are also produced from a metal alloy. Gear mechanisms of this type afford the advantage that they are extremely torsionally stiff and can be highly loaded. Gear mechanisms which consist at least partially of plastic or comprise components made from plastic afford the advantage that they can have a low weight. The expression “flexurally stiff” means, in particular, a flexural stiffness about a transverse axis of the tooth segment. This means, in particular, that, if the tooth is viewed as a bar from a tooth root to a tooth tip, there is a flexural stiffness which at least substantially rules out bending deformations between the tooth tip and the tooth root. An extremely high load-bearing capability and torsional stiffness of the gear mechanism is achieved by way of the flexural stiffness.

In typical embodiments, a pivoting segment is arranged between the tooth and the cam disk, which pivoting segment is mounted on an anti-friction bearing which in turn lies on the cam disk. Advantageous embodiments comprise a pivoting segment which is arranged between the cam disk and in each case at least one tooth. The pivoting segment makes tilting of the tooth possible relative to the surface of the cam disk or relative to the pivoting segment. At least two teeth are typically mounted on one pivoting segment. In further embodiments, precisely one tooth is mounted on in each case one of the pivoting segments, for example a round tooth or a flat tooth. Flat teeth can be secured in the bearing against rotation about their own axis. A plurality of teeth which are mounted on one pivoting segment are typically arranged next to one another in a row in the axial direction. The smooth running of the pivoting segments can be increased by way of arrangements of this type of a plurality of teeth or by way of flat teeth.

The teeth are typically connected in each case loosely to the respective pivoting segments. Preferred pivoting segments comprise a profile or a tooth bearing face which prevents sliding of the tooth from the pivoting segment or sliding of the pivoting segment at least in one direction. It should be taken into consideration that in this way the pivoting segments are held in their position in the circumferential direction relative to the tooth carrier by way of the guided teeth. A profile of this type can be, for example, a bead which engages into a depression. The pivoting segment can have a bead or a depression. In further embodiments, the teeth can be fastened to the pivoting segments, for example by way of joints or using undercuts.

The pivoting segments preferably have mutually facing edges with elevations and depressions, for example an undulating shape or a zigzag shape. This affords the advantage that needle rollers which are arranged below the pivoting segments are held reliably in the space between the pivoting segments and the drive element even in the case of a relatively great spacing between the pivoting segments.

Typical embodiments of the invention comprise a cam disk as drive element. The cam disk preferably has a non-circular or non-ellipsoid arcuate shape or curve. The non-circular or non-ellipsoid arcuate shape affords the advantage that different cams can be used, in order, for example, to set different transmission ratios. In the context of this application, eccentrics are typically included under circular or ellipsoid shapes, since in the case of eccentrics it is only the rotational axis which does not correspond to the center axis of the circular shape; there is nevertheless a circular shape, however. Typical cam disks comprise at least or precisely two elevations which are typically arranged uniformly distributed over the circumference. The elevations can also be called maxima. A plurality of elevations bring more teeth into engagement with the toothing system or internal toothing system.

In typical embodiments, the tooth carrier or the toothing system is of circular configuration. This affords the advantage of simple geometry for the tooth carrier and the toothing system. The transmission of force typically takes place on the slow side of the gear mechanism between the toothing system and the tooth carrier. This affords the advantage that the path for the transmission of force is extremely short, with the result that an extremely high stiffness can be achieved. Embodiments which meet these conditions are, in a non-exhaustive list: a gear mechanism with an inner cam disk as drive and an outer internal gear with a toothing system, the tooth carrier being arranged between the internal gear and the cam disk; an outer cam disk with an inner profiling on an internal gear for driving the radially movable teeth inward against a toothing system which is arranged on a gearwheel or a rack.

The toothing system and the teeth typically have curved flanks. Examples for curvatures of the flanks are a cylindrical curvature or a curvature in the form of a logarithmic spiral. Reference is made to DE 10 2007 011 175 A1 for one possible embodiment of a curvature in the form of a logarithmic spiral. The curved surface affords the advantage that the flanks which are in engagement bear over a full area and not merely in a linear or punctiform manner. In this way, an extreme stiffness is achieved during the transmission of force between the toothing system and the teeth.

Typical embodiments comprise a bearing with pivoting segments and rolling bodies between the profiling and the teeth. At least two teeth which lie next to one another and, in particular, lie axially in parallel or offset are typically provided per pivoting segment. In this way, the pivoting segment can be stabilized in its raceway or on its respective running face. Rotations of the pivoting segment about a radial axis can be avoided. Rolling bodies of embodiments are typically configured as cylindrical rollers, tapered rollers or needle rollers.

Typical embodiments comprise one or at least two rolling body rows which are typically arranged axially next to one another and/or so as to run in parallel per circumferential row of pivoting segments. One pivoting segment can be mounted on at least two circumferentially parallel rolling body rows. Here, in the case of two or more rows of teeth which are arranged in parallel, in each case one rolling body row can be arranged below a tooth row, with the result that the pivoting segment experiences support under in each case one tooth row. A typical arrangement is, for example, an arrangement of the row of teeth radially above the rolling body row with a pivoting segment which lies in between. The center axis of the respective teeth typically lies in the middle 80% or middle 50% or middle 20% or at least substantially centrally over the respective rolling bodies. In this way, the rolling bodies are loaded substantially centrally. In typical embodiments, one of the rolling body rows is arranged in an axial plane with one of the rows of teeth. In each case one row is typically in an axial plane, the same axial plane meaning, for example, that the centers coincide at least substantially and/or the teeth are arranged completely within the axially extended region of the respective rolling body row.

Herein, in case not otherwise indicated, the term “axial plane” refers to a plane which is perpendicular to the axial direction, typically perpendicular to the axial direction of the gear mechanism, i.e. perpendicular to the rotational axis of the gear mechanism. In case of the teeth, the axial direction might denote the direction of the longest dimension of a single tooth. Typically, the axial direction of a single tooth is at least substantially perpendicular to the axial direction of the gear mechanism.

The profiling typically comprises at least two parallel running faces. In typical embodiments, in each case one of the rolling body rows is arranged in or on in each case one of the parallel running faces. In this way, rolling bodies which run in parallel have dedicated running faces and/or each rolling body row can be guided in a defined, dedicated running face.

The profiling is typically split by way of at least one circumferential central rim. In this way, parallel running faces can be provided in embodiments, typically on both sides of the central rim. It is possible to provide a plurality of parallel central rims, in order to provide more than two parallel running faces, in typical embodiments with two rows of teeth or more than two rows of teeth.

The cam disk typically comprises two circumferential edge rims. The edge rims typically delimit in each case one outer running face axially to the outside. The running faces are typically delimited centrally by way of a central rim. In typical embodiments, the edge rims delimit two running faces by way of precisely one central rim, and in further embodiments a plurality of central rims are provided and therefore also more than two running faces and optionally also more than two rolling body rows.

The central rim and/or the edge rims can in each case have a height which corresponds at least substantially to the diameter of the rolling bodies. In further embodiments, they can have a height which is slightly smaller, for example between 0% and 10% or between 0% and 5% smaller, than the diameter. In further embodiments, the height of the central rim and/or the edge rims lies at merely between 50% and 80% or between 50% and 95% of the diameter of the rolling bodies. The central rim and edge rims can have different heights; for example, the central rim can be lower than the edge rims. In embodiments, edge rims are also used as a stabilizing face for the pivoting segments. In further embodiments, the central rim is higher than the edge rims, for example if the central rim is used for stabilizing the smooth running of the pivoting segments.

The pivoting segments typically lie in each case with an anti-friction bearing face on one side on at least part of the rolling bodies, and have in each case one tooth bearing face on a side which lies opposite the anti-friction bearing face, at least two teeth typically being mounted in an articulated manner on one tooth bearing face. In typical embodiments, the tooth bearing face is configured in such a way that a common rotational axis for the at least two teeth is formed by way of the tooth bearing face. Typical tooth bearing faces of embodiments comprise in each case one round face section for in each case at least one tooth and/or a plurality of teeth which are arranged axially in parallel, the center point of the radius of the round face section coinciding at least substantially with the anti-friction bearing face. A rotational axis of the tooth bearing which is formed by way of the tooth bearing face typically coincides at least substantially with the anti-friction bearing face. The tooth bearing face can be configured as a bead and/or as a circular section in the region of the tooth bearing.

Typical gear mechanisms of embodiments comprise circumferentially parallel rows of teeth. At least or precisely two rows of teeth are typical. The teeth typically run in circumferentially parallel rows of guides of the tooth carrier.

In typical embodiments, in each case at least two parallel teeth are arranged on one pivoting segment. The two parallel teeth typically belong to the two parallel rows of teeth which are guided, for example, in guides in the tooth carrier. In embodiments, two parallel teeth of parallel rows of teeth are arranged behind one another in the axial direction on a pivoting segment, typically on a bead or in a depression of the pivoting segment.

Typical tooth carriers of embodiments comprise at least one radially inwardly or radially outwardly extending run-on flange which engages over the pivoting segments at least partially in the axial direction. In this way, there is the option to dispense with additional run-on disks. The run-on flange can be configured integrally with the tooth carrier or can be fastened to the tooth carrier. Typical embodiments do not have a run-on disk. Some embodiments comprise a run-on disk at least on one side axially next to the pivoting segments and/or next to the rolling bodies for guiding the pivoting segments.

In embodiments with a run-on flange on the tooth carrier, at least one of the run-on flanges typically comprises an output bearing face which interacts directly with output bearing rolling bodies. A bearing is typically integrally configured between the tooth carrier and the cam disk or a shaft which is connected to the cam disk. Embodiments of this type can be space-saving. The output bearing rolling bodies are typically mounted directly on the cam disk. In further embodiments, a bearing with bearing rings is provided between the tooth carrier and the cam disk. This can simplify the production.

Typical gear mechanisms comprise a plurality of pivoting segments which are arranged circumferentially on rolling bodies and lie in each case with an anti-friction bearing face on the rolling bodies. The rolling bodies are typically mounted on the cam disk. The rolling bodies reduce the frictional resistance.

In each case one rim bearing face is typically arranged on the pivoting segments in the axial direction on both sides and/or on the edge side of the pivoting segment. In further embodiments, rim bearing faces are arranged centrally in the axial direction on the pivoting segments, which rim bearing faces are provided, for example, to lie on a central rim. In embodiments with two both-sided and/or edge-side rim bearing faces, the rim bearing faces can lie at least partially on the edge rims of the cam disk. In this way, tilting of the pivoting segments can be prevented and smooth running can be ensured.

### BRIEF DESCRIPTION OF THE DRAWING

In the following text, the invention will be explained in greater detail using the appended drawing, in which:

FIG. 1 diagrammatically shows a first embodiment of the invention in a detail of a longitudinal section through a gear mechanism.

### DESCRIPTION OF EXEMPLARY EMBODIMENTS

In the following text, typical embodiments of the invention will be described using the FIGURES, the invention not being restricted to the exemplary embodiments, but rather the scope of the invention being determined by the claims. During the description of the embodiment, identical reference numerals are used in some circumstances for identical or similar parts in different FIGURES and for different embodiments, in order to make the description clearer.

This does not mean, however, that corresponding parts of the invention are restricted to the variants which are shown in the embodiments.

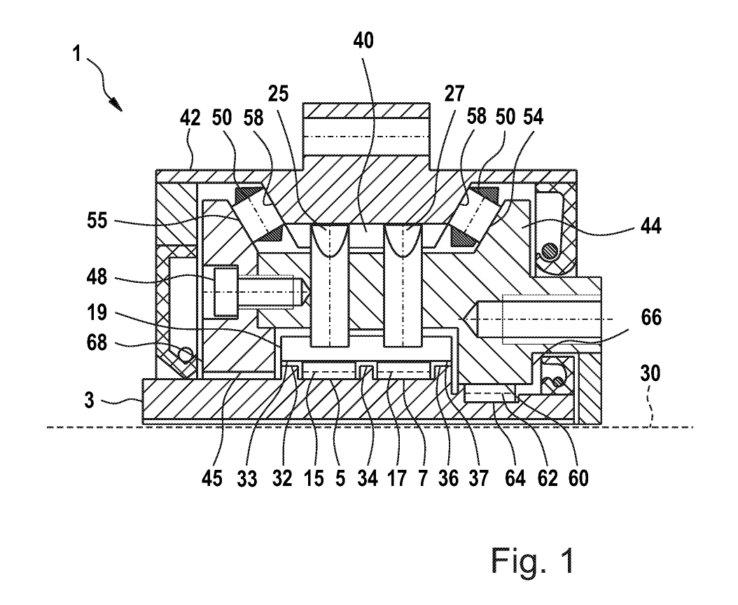

FIG. 1 shows a typical embodiment of a gear mechanism 1 according to the invention in a detail of a sectional view. Reference is made, for example, to DE 10 2007 011 175 A1 for further explanations in respect of the method of operation of the gear mechanism and for further technical features.

The gear mechanism 1 comprises a cam disk 3 which is configured integrally with a drive shaft and, as a result, has a design which is elongate in the axial direction. The cam disk 3 comprises a profiling which comprises two running faces 5 and 7. The profiling and therefore also the running faces 5 and 7 have a radius which changes over the circumference; in particular, they have two maxima which can also be called elevations and two minima, the two running faces 5 and 7 having the same angular position of the changing radii.

In alternative embodiments, three or more running faces can also be provided for rolling bodies.

Rolling bodies 15 and 17 are mounted on the running faces 5 and 7. Pivoting segments 19 are mounted on said rolling bodies 15 and 17, merely one pivoting segment 19 being shown in the sectional view of FIG. 1. The pivoting segment 19 therefore lies on two circumferential rolling body rows with the rolling bodies 15 and 17.

As in typical embodiments, a circumferential row of pivoting segments also lies on two circumferentially parallel rolling body rows in the embodiment of FIG. 1. Further embodiments can comprise three or more rolling body rows which run in parallel and on which a row of pivoting segments is mounted. In further embodiments with a plurality of rows of pivoting segments, two rolling body rows are typically provided per row of pivoting segments.

The pivoting segment 19 comprises a bead on the radial outer side of the pivoting segment 19, which bead engages into grooves of two teeth 25 and 27. The bead forms a tooth bearing face which has a radius, the center point of which coincides with the anti-friction bearing face of the pivoting segment 19, which anti-friction bearing face lies opposite. The teeth 25 and 27 therefore have an identical rotational axis with regard to the common pivoting segment.

The teeth 25 and 27 are mounted in their axial position with regard to the longitudinal axis 30 of the gear mechanism 1 at least substantially centrally over the rolling bodies 15 and 17, in each case one tooth 25 or 27 being mounted via one rolling body 15 or 17. In this way, a continuous transmission of force through the pivoting segment 19 is achieved. Moreover, the rolling bodies 15 and 17 which are configured as needle rollers are loaded approximately centrally. Furthermore, the overall length of the rolling bodies 15 and 17 themselves can be reduced by way of said measure, it being possible for the running stability to be increased.

The cam disk 3 has two edge rims 32 and 36 and a central rim 34 for delimiting the running faces 5 and 7. The central rim 34 lies centrally between the running faces 5 and 7 for the rolling bodies 15 and 17. The two edge rims 32 and 36 restrict the freedom of movement of the rolling bodies 15 and 17 in each case in the axial direction toward the outside. In this way, the two running faces 5 and 7 are provided between the edge rims 32 and 36 with the central rim 34.

The pivoting segment 19 has rim bearing faces 33 and 37 which can be supported in each case on the edge rims 32 and 36. In this way, the smooth running of the pivoting segment 19 is increased. The edge rims 32 and 36 and the central rim have at least substantially a height which corresponds to the diameter of the rolling bodies 15 and 17.

In further embodiments, the rim bearing faces are of elevated configuration, with the result that the edge rims and possibly the central rim can be of lower configuration than the diameter of the rolling bodies. Nevertheless, stabilization can be achieved by way of the elevated rim bearing faces at the pivoting segment.

The teeth 25 and 27 engage into a common toothing system 40 which is configured integrally with a housing 42 of the gear mechanism 1. The teeth 25 and 27 are received in radially oriented guides in a second tooth carrier part 44 of a tooth carrier. Moreover, the tooth carrier also comprises a first tooth carrier part 45 which is connected to the second tooth carrier part 44 by way of a connecting means 48 which is configured as a screw. A plurality of connecting means 48 (a total of six in the exemplary embodiment of FIG. 1) are provided over the circumference of the tooth carrier.

In further embodiments, a different number of connecting means can also be provided, an odd number also being possible. The connecting means can be distributed uniformly over the circumference of the tooth carrier, and it is also possible in contrast to provide different angular intervals, for example in order to make it possible to join the two tooth carrier parts together only in a defined angular position. Thus, in the embodiment of FIG. 1, the angles between the connecting means are not uniform by way of example, in order to permit a reassembly of the tooth carrier parts of the tooth carrier only in a defined relative angular position with respect to one another. In further embodiments, grooves, pins or other contours can be provided, or markings can be provided, in order to permit or make possible reassembly only in a defined angular position. In this way, machining of the tooth carrier in one clamping is possible, the tooth carrier parts subsequently being released again from one another, in order then to be connected to one another again in the gear mechanism.

In further embodiments, the tooth carrier is configured in one piece and/or is mounted by way of bearings with bearing shells.

Tooth carrier rolling bodies 50 which are mounted at an angle of approximately 75 degrees with respect to the longitudinal axis 30 of the gear mechanism 1 are provided for mounting the tooth carrier on the housing 42. Here, the angular positions of the tooth carrier rolling bodies 50 are mirror-symmetrical with respect to an axial sectional plane of the gear mechanism 1 with respect to one another, in order to achieve reliable mounting of the tooth carrier in the housing 42.

Further embodiments have different angular positions of the tooth carrier rolling bodies, for example between 0° and 80° relative to the longitudinal axis of the gear mechanism.

The tooth carrier rolling bodies 50 are mounted in each case directly on tooth carrier bearing faces 54 and 55 of the first tooth carrier part 44 and the second tooth carrier part 45. On the housing side, the tooth carrier rolling bodies 50 are mounted on housing bearing faces 58 of the housing 42. The tooth carrier rolling bodies 50 therefore roll in each case directly on the tooth carrier bearing faces 54 and 55 and on the housing bearing faces 58. In this way, compact integral mounting is achieved which takes up a small amount of installation space.

Furthermore, in the exemplary embodiment of FIG. 1, the output bearing is also configured as an integral bearing, the tooth carrier or, in the case of the embodiment of FIG. 1, the second tooth carrier part 44 having an output bearing face 60, on which output bearing rolling bodies 62 which are configured as rollers roll directly. A further output bearing face 64 which likewise interacts directly with the output bearing rolling bodies 62 is configured on the cam disk. As a result, the output bearing rolling bodies roll directly on the cam disk 3. In this way, an integrated bearing is provided for a compact overall design.

The output bearing face 60 of the second tooth carrier part 44 is part of an output-side run-on flange 66 which prevents yielding of the pivoting segments 19 in the output-side direction. A compact overall design and high stiffness are achieved by way of the integral configuration of the run-on flange 66 with the second tooth carrier part 44.

The first tooth carrier part 45 has a further run-on flange 68 which likewise prevents yielding of the pivoting segments 19 in the opposite direction.

A further bearing for the cam disk 3 which is configured integrally with a drive shaft is typically provided so as to lie opposite the output, that is to say so as to lie opposite the side of the output bearing. However, this lies outside the illustrated region of FIG. 1. On the drive side, there is also in some circumstances a larger installation space in the radial direction, with the result that the drive-side bearing can be optionally configured as a bearing with separate running faces. In further embodiments, the drive bearing can also be configured as an integral bearing.

1. Gear mechanism, in particular coaxial gear mechanism or linear gear mechanism, having
a toothing system,
a tooth carrier with radially oriented guides,
teeth which are received in the guides for engagement with the toothing system, the teeth being mounted in the guides such that they can be displaced radially relative to the tooth carrier in the direction of their longitudinal axis,
a cam disk for radially driving the teeth, the cam disk having a circumferential profiling,
rolling bodies which are arranged on the profiling, and
a plurality of pivoting segments for mounting the teeth, the pivoting segments being arranged on the rolling bodies,
the rolling bodies being arranged on the profiling in at least two rolling body rows which are parallel in the circulating direction of the cam disk.

2. Gear mechanism according to claim 1, the profiling having at least two parallel running faces.

3. Gear mechanism according to claim 1, the profiling being split by way of at least one circumferential central rim.

4. Gear mechanism according to claim 3, the cam disk comprising two circumferential edge rims.

5. Gear mechanism according to claim 1 having circumferentially parallel rows of teeth.

6. Gear mechanism according to claim 1, in each case at least two parallel teeth being arranged on one pivoting segment.

7. Gear mechanism according to claim 1, the pivoting segments lying in each case with an anti-friction bearing face on one side on at least part of the rolling bodies, and having in each case one tooth bearing face on a side which lies opposite the anti-friction bearing face, at least two teeth being mounted in an articulated manner on one tooth bearing face.

8. Gear mechanism according to claim 7, the tooth bearing face being configured in such a way that a common rotational axis for the at least two teeth is formed by way of the tooth bearing face.

9. Gear mechanism according to claim 5, one of the rolling body rows being arranged in an axial plane with one of the rows of teeth.

10. Use of a gear mechanism according to claim 1.
